(19) United States
(12) Patent Application Publication
(10) Pub. No.: US 2011/0196575 A1
(43) Pub. Date: Aug. 11, 2011

(54) Forced steering

(76) Inventors: Josef Scharmüller, SR., Fornach (AT); Josef Scharmüller, Fornach (AT)

(21) Appl. No.: 13/020,386

(22) Filed: Feb. 3, 2011

(30) Foreign Application Priority Data
Feb. 3, 2010 (AT) A 147/2010

(51) Int. Cl. B62D 6/00

(52) U.S. Cl. 701/42

(57) ABSTRACT

A forced steering arrangement for steering a vehicle trailer coupled to a towing vehicle includes a measuring device for determining a pivot angle between the towing vehicle and the vehicle trailer, a control device having an input coupled to the measuring device and an output, and a steering device coupled to the output of the control device for turning the wheels of at least one steered axle of the vehicle trailer. The measuring device is also configured to determine a twist between the towing vehicle and the vehicle trailer.

The invention relates to a forced steering with a measuring device according to the preamble of claim 1.

The measuring device is used to determine the pivot angle between the towing vehicle, particularly the tractor, and the vehicle trailer. The pivot angle is 0° when driving in a straight line and less than zero or greater than zero when driving through turns - commensurate with the steering angle. When driving the tractor-trailer composition formed by the towing vehicle and the vehicle trailer, a measurement signal corresponding to the determined pivot angle is transmitted from the measuring device to an input of a control device. A control signal which depends on this measurement signal is generated in the control device, and the control signal is transmitted to a steering device for turning the wheels of at least one steered axle of the vehicle trailer. The wheels steered in this way are force-steered by the forced steering, wherein on the vehicle trailer with forced steering at least the wheels of the steered axle of the vehicle trailer are force-steered.

It is an object of the invention to increase the accuracy and reliability of the forced steering.

According to the invention, this is attained by the features of claim 1.

This leads to the advantage that in addition to the pivot angle, the twist between the towing vehicle and the vehicle trailer can also be determined, with twisting occurring essentially about the longitudinal axis of the tractor-trailer composition, when the tractor-trailer composition is located on a twisted and hence uneven surface. Advantageously, the measurement signal transmitted from the measuring device to the input on the control device while driving then corresponds to the determined pivot angle and the determined twist. The control device, which receives at its input the measurement signal, then can take into consideration both the pivot angle and the twist when generating the control signal, thereby increasing the accuracy and reliability of the forced steering.

The invention also relates to a method for forced steering of a vehicle trailer coupled to a towing vehicle according to the preamble of claim 9.

It is an object of the method to increase the accuracy and reliability of the forced steering.

According to the invention, this is attained with the features of claim 9.

Advantageously, the method also provides the aforementioned advantages and advantageous effects.

The dependent claims, which like the claims 1 and 9 also form part of the description, recite additional advantageous embodiments of the invention.

In particular for forming a redundant system, an additional measuring device may be arranged in addition to the measuring device.

The invention will now be described in more detail with reference to the appended drawings which only illustrates preferred exemplary embodiments.

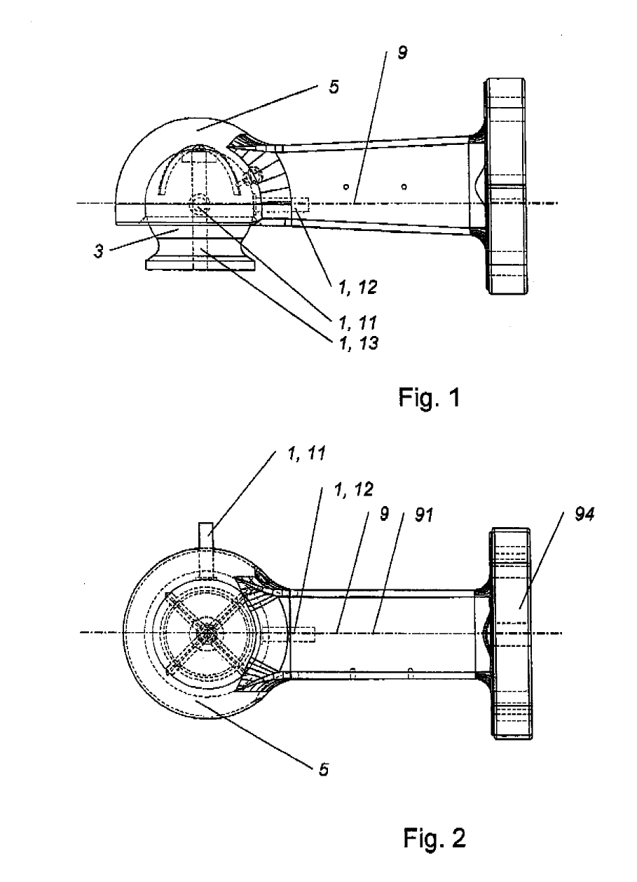

FIG. 1 shows a part of the forced steering of a particularly preferred first embodiment in a side view;

FIG. 2 shows the part of the forced steering of FIG. 1 in a top view;

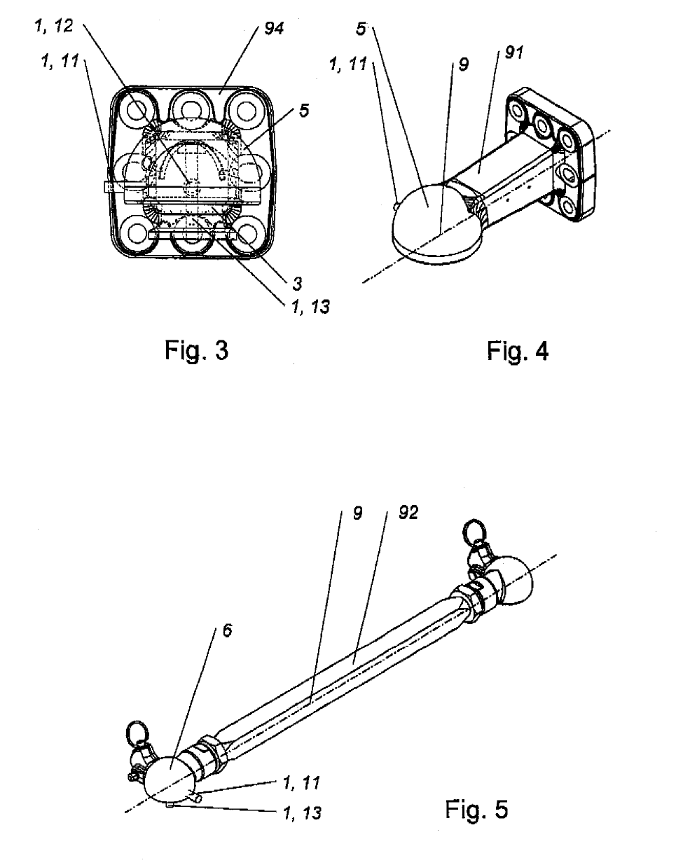

FIG. 3 shows the part of the forced steering of FIG. 1 in a front view;

FIG. 4 shows the part of the forced steering of FIG. 1 in an oblique view;

FIG. 5 shows a part of the forced steering of an advantageous second embodiment in a side view;

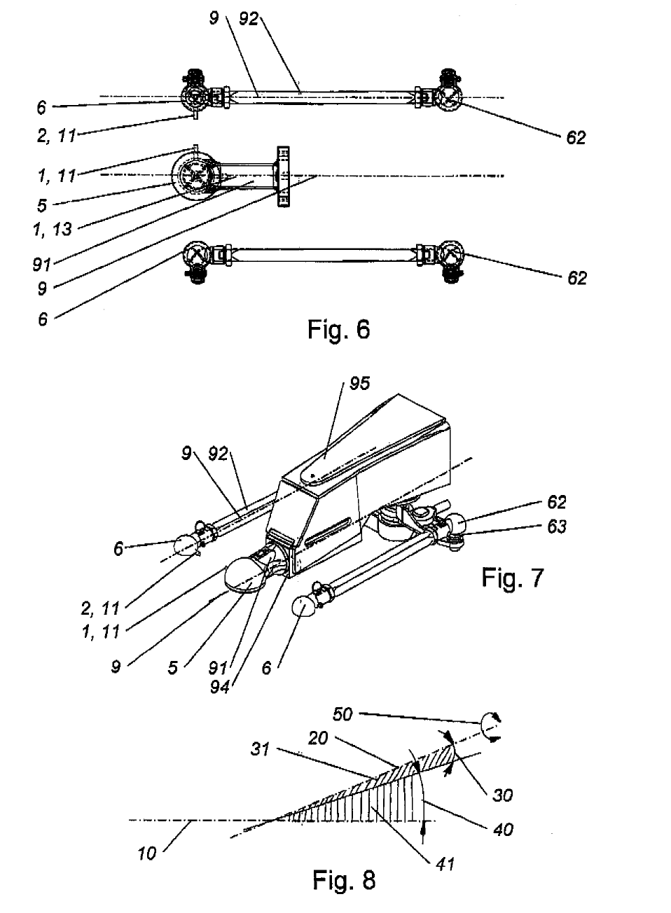

FIG. 6 shows a part of the forced steering of an advantageous third embodiment in a top view;

FIG. 7 shows a part of the forced steering of the advantageous third embodiment and an additional part of a vehicle trailer in an oblique view;

FIG. 8 shows schematically a determination of the relative arrangement of two axes to one another in three-dimensional space, wherein the two axes intersect in a point; and

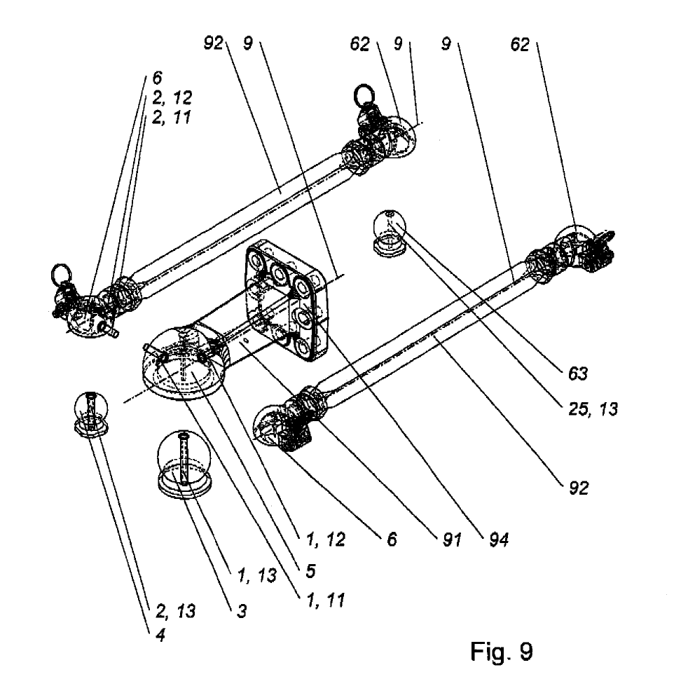

FIG. 9 shows a part of the forced steering of an advantageous fourth embodiment in an oblique view, wherein a load coupling ball and a load coupling socket as well as a forced-steering coupling ball and a forced-steering coupling socket are illustrated in an exploded view.

FIGS. 1 to 7 and 9 show parts of advantageous embodiments of a forced steering for steering a vehicle trailer coupled to a towing vehicle with a measuring device 1 for determining the pivot angle between the towing vehicle and the vehicle trailer, a control device having an input connected to the measuring device 1, and a steering device connected with an output of the control device for turning the wheels of at least one steered axle of the vehicle trailer. For increasing the accuracy and reliability of the forced steering, in particular on uneven terrain, it is proposed to further configure the measuring device 1 for determining the twist between the towing vehicle and the vehicle trailer.

Advantageously, this forced steering enables a method for forced steering of the vehicle trailer coupled to a towing vehicle, wherein the pivot angle between the towing vehicle and the vehicle trailer is determined with the measuring device, the measurement signal is transmitted from the measuring device to an input of a control device, a control signal is generated in the control device, and the control signal is transmitted to a steering device for turning the wheels of at least one axle of the vehicle trailer. According to the method, the measuring device 1 advantageously also determines the twist between the towing vehicle and the vehicle trailer.

In the coupled state, the towing vehicle and the vehicle trailer form a tractor-trailer composition. The towing vehicle may be, in particular, a tractor or a tractor unit.

The forced steering can, in one embodiment of the forced steering, include a hydraulic system with at least one master cylinder and with at least one slave cylinder. The master cylinder is hereby provided for controlling the position of the slave cylinder, and the slave cylinder is hereby provided to turn the wheels of the steered axle. In particular, the slave cylinder may be encompassed by the control device. In particular, the master cylinder may be encompassed by the steering device.

In another embodiment of the forced steering, the forced steering may include an electrical system with at least one actuator motor. The actuator motor operates to turn the wheels of the steered axle, wherein the actuator motor is encompassed by the steering device.

The pivot angle is 0° when traveling along a straight line and less than zero - corresponding to the steering angle—when negotiating a left turn, or greater than zero but negotiating a right turn. The pivot angle is measured between a longitudinal axis of the towing vehicle and a measurement axis 9 of the forced steering. In particular, the measurement axes 9 may be parallel to the longitudinal axis of a tow bar 91 and/or parallel to a steering rod 92 of the forced steering. If the toolbar 91 is connected with a vehicle trailer frame and prevented from pivoting, then the measurement axis 9 of the forced steering can be parallel to ₜhe longitudinal axis of the vehicle trailer. If the measurement axis 9 of the forced steering is parallel to a horizontal plane, then the pivot angle is determined in the horizontal plane. In particular, this arrangement of the measurement axis 9 may exist when the tractor-trailer composition is arranged on a horizontal plane.

The twist represents the rotation of the measurement axis 9 about itself. This may correspond tilting the vehicle trailer about the longitudinal axis of the vehicle trailer relative to the towing vehicle, which may be particularly the case when the tractor-trailer composition is located on a warped surface of an uneven terrain.

With the three-dimensional arrangement of the measurement axis 9 with respect to the longitudinal axis of the towing vehicle, an additional tilt angle may occur which is normal to the pivot angle. The tilt angle between the towing vehicle and the vehicle trailer is different from 0° when the tractor-trailer composition moves across an uneven surface having cusps, in particular across a cusp, or through an uneven surface having indentations, in particular through a depression, wherein the tilt angle is in one of these two situations smaller than 0° and in the other of the two situations greater than 0°. In an advantageous embodiment of the forced steering, the measuring device 1 may further be configured to determine the tilt angle between the towing vehicle and the vehicle trailer.

The tilt angle, the pivot angle and the twist thus define the arrangement and the rotation of the measurement axis 9 with respect to the longitudinal axis of the towing vehicle in the three dimensions in space, as is schematically illustrated in FIG. 8 with reference to a first axis 10 and a second axis 20.

FIG. 8 shows the first axis 10 and the second axis 20, which intersect with each other at a single point and which are—schematically—arranged in three-dimensional space. In particular, the first axis 10 may correspond to the longitudinal axis of the towing vehicle, whereas the second axis 20 can in particular correspond to the measurement axis 9 of the forced steering. In the general arrangement of the first axis and the second axis 10, 20, a first angle 30, corresponding to the tilt angle, is formed between the two axes 10, 20 in a vertical plane 31, a second angle 40, corresponding to the pivot angle, is formed between the two axes 10, 20 in a tilted plane 41, and a third angle 50, corresponding to the twist, corresponding to the rotation of the second axis 20 about itself is formed. The orientation and rotational of the second axis 20 relative to the first axes 10 are unambiguously determined from the determination of the first angle 30, the second angle 40 and third angle 50. Accordingly, the orientation and rotation of the measurement axis 9 relative to the longitudinal axis of the towing vehicle are unambiguously determined by the determination of the pivot angle, the tilt angle and the twist. Advantageously, the control signal can be determined with particular reliability and accuracy, so that the precision and reliability of the forced steering is particularly high.

As shown in FIGS. 7 and 8, the pivot angle is measured in a tilt plane corresponding to the tilted plane 41, wherein the tilted plane may be spanned by the longitudinal axis of the towing rod 91 and the longitudinal axis of the steering rod 92. The tilt angle between the longitudinal axis of the towing vehicle and the tilt plane affect the determined pivot angle. By further determining with the measuring device 1 the tilt angle between the towing vehicle and the vehicle trailer, the effect of the tilt angle can be taken into consideration when generating the control signal, thereby making the forced steering particularly precise and reliable.

In particular, the measurement signal of the measuring device 1 may include two mutually independent signals, namely a pivot angle measurement signal depending only on the pivot angle and a twist measurement signal depending only on the twist.

In particular, the measurement signal of the measuring device 1 may include three mutually independent signals, namely the pivot angle measurement signal depending only on the pivot angle, the twist measurement signal depending only on the twist, and a tilt angle measurement signal depending only on the tilt angle.

Advantageously, the measuring device 1 may include at least one sensor 11 configured to determine the measurement signal. The measurement signal determined with the sensor 11 is hence available in electronic form and can thus form an electronic input signal of the control device. In particular, the measurement signal can be amplified and the amplified signal can form the electronic input signal of the control device. In an advantageous embodiment, the control device may determine electronic output signals that depend on the electronic input signals. The electronic output signals can in turn determine, in particular control, the position of the master cylinder, and/or can determine, in particular control, the position of the actuator motor.

The sensors may be configured to determine the relative arrangement of the at least two signal points of the sensor 11 having a predetermined arrangement, wherein at least one of the at least two signal points is attached on the towing vehicle at a fixed location and at least one other of the at least two signal points is attached on the vehicle trailer at a fixed location, for example on the frame of the vehicle trailer, whereby the measuring device 1 is affixed on both the towing vehicle and the vehicle trailer.

In another embodiment of the sensor 11, the relative arrangement of the vehicle trailer, for example of the frame of the vehicle trailer, relative to the spaced-apart sensor 11 may be determined with a laser and/or with sound, whereby the sensor 11 is affixed on the towing vehicle at a fixed location, whereas the measuring device 1 is affixed only on the towing vehicle.

For forming a redundant measuring system, an additional measuring device 2 may be arranged in addition to the measuring device 1. Advantageously, if one of the two, measuring devices 1, 2 fails, a measurement signal can still be determined by the other of the two measuring devices 1, 2 and transmitted to the input of the control device, whereby the forced steering remains operational. Advantageously, an error message is outputted when the measurement signals exceed a predeterminable maximum deviation, referring to a deviation between the measurement signal from the measuring device 1 and the measurement signal from the additional measuring device 2, so that the operability of the forced steering can be easily controlled. Advantageously, an average measurement value may be outputted as a measurement signal by the measuring device 1 and the additional measuring device 2—unless one of the two measuring devices 1, 2 has failed—and transmitted to the input of the control device, which produces the statistical error and thus increases the measurement accuracy. Both measuring devices 1, 2 are hereby used, with the average value of the two measurement signals being formed in the control device. In this context, the measuring device 1 may determine a first measurement signal 1 and the additional measuring device 2 a second measurement signal.

In particular, the additional measuring device 2 can be constructed similar to the measuring device 1. In particular, the additional measuring device 2 may also include at least one sensor 11 for determining an electronic signal. In particular, the measuring device 1 may be essentially arranged in a load coupling ball 3 and/or essentially in a load coupling socket 5, as provided in the first embodiment of the forced steering, wherein in the first embodiment the load coupling ball 3 and the load coupling socket 5 are encompassed by the forced steering. In this operating position, the load coupling ball 3 is mounted on the towing vehicle. In the operating position, the load coupling socket 5 is mounted on the vehicle trailer. The load coupling ball 3 and the load coupling socket 5 are configured to be coupled with each other, with the towed load being pulled via this coupling. The coupled load coupling ball 3 and load coupling socket 5 are schematically illustrated in FIGS. 1 and 3. In a modification of the first embodiment of the forced steering, the measuring device 1 and/or the second measuring device 2 may be arranged essentially in a load coupling ball 3 and/or essentially in a load coupling socket 5.

In a second embodiment of the forced steering, the measuring device 1 is essentially arranged in a forced-steering coupling ball 4 provided in addition to the load coupling ball 3 and/or essentially in a forced-steering coupling socket 6 provided in addition to the load coupling socket 5, wherein in the second embodiment the forced-steering coupling ball 4 and the forced-steering coupling socket 6 are encompassed by the forced steering. In the operating position, the forced-steering coupling ball 4 is mounted on the towing vehicle. In the operating position, the forced-steering coupling socket 6 is mounted on the vehicle trailer. The forced-steering coupling ball 4 and the forced-steering coupling socket 6 are also configured to be coupled with one another, whereby essentially no towed load is pulled with this coupling. In a modification of the second embodiment of the forced steering, the measuring device 1 and/or the additional measuring device 2 may be essentially arranged in the forced-steering coupling ball 4 and/or essentially in the forced-steering coupling socket 6.

In the third embodiment of the forced steering, the measuring device 1 is essentially arranged in the load coupling ball 3 and/or essentially in the load coupling socket 5, and the additional measuring device 2 is essentially arranged in the forced-steering coupling ball 4 and/or essentially in the forced-steering coupling socket 6. Advantageously, both the pivot angle and twist in the region of the load coupling ball 3 as well as the pivot angle and the twist in the region of the forced-steering coupling ball 4 are determined, which ensures the particularly high measurement accuracy and the particularly high measurement reliability for the pivot angle and the twist.

In particular, the measuring device 1 may include at least three sensors 11, 12, 13, namely the first sensor 11, a second sensor 12, and a third sensor 13, as provided in the first and the second embodiment of the forced steering.

In particular, the second measuring device 2 may also include at least three sensors 11, 12, 13, as is envisioned in the third embodiment of the forced steering.

In a particularly advantageous modification, the measuring device 1 may include the three sensors 11, 12, 13 for determining the rotation about three substantially mutually perpendicular axes. In this context, the three sensors 11, 12, 13 may be provided for determining the rotation of the load coupling socket 5 about the load coupling ball 3 and/or of the forced-steering coupling socket 6 about the forced-steering coupling ball 4 about three substantially mutually perpendicular axes, as provided according to the first and the second embodiment of the forced steering. The three-dimensional rotation of the respective coupling socket about the corresponding coupling ball can then be determined with great precision and high reliability, and the pivot angle, the tilt angle and the twist can be derived from this so determined three-dimensional rotation with great precision and high reliability.

Advantageously, the first sensor 11 may be provided for determining the pivot angle. Advantageously, the second sensor 12 may be provided for determining the tilt angle. Advantageously, the third sensor 13 may be provided for determining the twist. The three sensors 11, 12, 13 independently determined the respective angle signals. The measurement signal therefore includes the respective angle signals which can be transmitted as individual signals to the input of the control device, whereby the input of the control device may include three signal inputs.

According to the first embodiment of the forced steering, one of the three sensors 11, 12, 13, in particular the third sensor 13, of the measuring device 1 may be arranged in the load coupling ball 3, whereas to of the three sensors 11, 12, 13 may be arranged in the load coupling socket 5. The measuring device 1 is here essentially arranged in the load coupling ball 3 and essentially in the load coupling socket 5. Advantageously, the three sensors 11, 12, 13 may be constructed in a simple manner, robust and cost-effectively, maybe arranged substantially perpendicular to one another, while nevertheless requiring only little installation space. In an advantageous modification of the first embodiment, to of the three sensors 11, 12, 13 may be arranged in the load coupling ball 3, whereas one of the three sensors 11, 12, 13 may be arranged in the load coupling socket 5.

Another advantageous modification, one or two of the three sensors 11, 12, 13, in particular the third sensor 13, of the additional measuring device 2 may be arranged in the forced-steering coupling ball 4, whereas the or the others of the three sensors 11, 12, 13 may be arranged in the forced-steering coupling socket 6.

The load coupling socket 5 may be encompassed by the towing rod 91, in particular formed as one piece with the towing rod 91. The towing rod 91 may be mounted on an additional vehicle trailer part 95 by way of a flange 94. The additional vehicle trailer part 95 may be, in particular, configured as an additional towing rod part, as schematically indicated in FIG. 7.

The forced-steering coupling socket 6 may be encompassed by the steering rod 92, in particular formed in one piece with the steering rod 92.

FIG. 9 shows parts of an advantageous fourth embodiment of the forced steering. In the fourth embodiment of the forced steering, the forced steering includes two forced-steering coupling balls 4, of which one is illustrated in FIG. 9, two steering rods 92, the load coupling ball 3, the towing rod 91 and two second forced-steering coupling balls 63, of which one is shown in FIG. 9. The towing rod 91 includes the load coupling socket 5. Each of the steering rods 92 includes on a first end a forced-steering coupling socket 6 and on a second end opposite the first end a second coupling socket 62. The forced-steering coupling socket 6 is intended to be arranged adjacent to the towing vehicle. The second coupling socket 62 is intended to be arranged spaced-apart from the towing vehicle and is configured ₜo be coupled to one of the two second forced-steering coupling balls 63. In the operating position, the second forced-steering coupling ball 63 is mounted on the vehicle trailer. The cooperating sockets and balls of the forced steering are illustrated in FIG. 9 separately in an exploded view, wherein in the coupled state the corresponding cooperating sockets and balls of the forced steering are in contact with one another.

According to the fourth embodiment, the forced steering includes three measuring devices, a measuring device 1, an additional measuring device 2 and a third measuring device 25. Each of these three measuring devices 1, 2, 25 includes at least one of the three sensors 11, 12, 13.

In particular, the measuring device 1 and the additional measuring device 2 may each include three sensors 11, 12, 13, in particular a sensor 11, a second sensor 12 and a third sensor 13. In this way, the measuring device 1 and the additional measuring device 2 are constructed to be completely redundant. The third sensor 13 of the measuring device 1 may here be arranged in the load coupling ball 3, whereas the first sensor 11 and the second sensor 12 of the measuring device 1 may be arranged in the load coupling socket 5. The third sensor 13 of the additional measuring device 2 may be arranged in one of the forced-steering coupling balls 4, whereas the first sensor 11 and the second sensor 12 of the additional measuring device 2 may be arranged in one of the forced-steering coupling sockets 6.

In particular, the third measuring device 25 may include the third sensor 13, in particular only the third sensor 13, as is also illustrated in FIG. 9. Advantageously, uneven terrain can thus be detected and taken into consideration when determining the tilt angle. In particular, the third sensor 13 encompassed by the third measuring device 25 may be arranged in the second forced-steering coupling ball 63, as schematically indicated in FIG. 9.

In a modification of the third measuring device 25, the third measuring device 25 may include at least one second sensor 12 and a third sensor 13. Advantageously, uneven terrain can thus be detected and taken into consideration when determining the tilt angle and the twist.

In a modification of the third measuring device 25, additionally included sensors, in particular a first sensor 11 and/or a second sensor 12, may be arranged in the second coupling socket 62.

Advantageously, all measuring devices 1, 2, 25 may be arranged in spaced-apart relationship from the towing vehicle. For example, in a different (unillustrated) embodiment of the forced steering, the measuring device 1 or the second measuring device 2 may be arranged in the region of the second end of at least one steering rod 92 of the forced steering. For example, in another (unillustrated) embodiment of the forced steering, the measuring device 1 may be arranged in the region of the second end of one of two steering rods 92 of the forced steering, whereas the additional measuring device 2 may be arranged in the region of the second end of the other of the two steering rods 92.

In a modification of the invention, the forced steering may include at least four measuring devices, i.e., at least the measuring device 1, the additional measuring device 2, the third measuring device 25, and a fourth measuring device.

In a preferred embodiment of the forced steering for steering a vehicle trailer coupled to a towing vehicle with a measuring device 1 for determining the pivot angle between the towing vehicle and the vehicle trailer, wherein an input of the control device is connected with the measuring device 1 and the steering device for turning the wheels of at least one steer axle of the vehicle trailer is connected to an output of the control device, the sensor 11 of the measuring device 1 or the third sensor 13 of the measuring device 1 are configured to determine the twist between the towing vehicle and the vehicle trailer, wherein the control device is configured to take into consideration the determined pivot angle and the determined twist when generating a control signal.

In the method for forced steering a vehicle trailer coupled to a towing vehicle, wherein the pivot angle between the towing vehicle and the vehicle trailer is determined by the sensor 11 of the measuring device 1, the measurement signal from the measuring device is transmitted to the input of the control device, a control signal which depends on the measurement signal is generated in the control device, and the control signal is transmitted to the steering device for turning the wheels of at least one axle of the vehicle trailer. In addition, the twist between the towing vehicle and the vehicle trailer is determined with the sensor 11 or with the third sensor 13 of the measuring device 1, wherein both the determined pivot angle and the determined twist are taken into consideration when generating the control signal.

Additional embodiments of the invention include only part of the aforedescribed features, whereby each feature combination, in particular also from the different aforedescribed embodiments, may be contemplated.

What is claimed is:

1. -12. (canceled)

13. A forced steering arrangement for steering a vehicle trailer coupled to a towing vehicle, comprising:
a measuring device for determining a pivot angle and a twist between the towing vehicle and the vehicle trailer,
a control device having an input coupled to the measuring device and an output, and
a steering device coupled to the output of the control device for turning the wheels of at least one steered axle of the vehicle trailer.

14. The forced steering arrangement of claim 13, wherein the measuring device comprises at least one sensor.

15. The forced steering arrangement of claim 13, wherein the control device determines electronic output signals in dependence of electronic input signals.

16. The forced steering arrangement of claim 13, wherein the measuring device is further configured to determine a tilt angle between the towing vehicle and the vehicle trailer.

17. The forced steering arrangement of claim 13, wherein the measuring device comprises at least three sensors for determining a rotation about three substantially mutually perpendicular axes.

18. The forced steering arrangement of claim 13, comprising an additional measuring device in addition to the measuring device to form a redundant system.

19. The forced steering arrangement of claim 18, further comprising a load coupling ball and a load coupling socket, wherein at least one of the measuring device and the additional measuring device is arranged substantially in the load coupling ball or substantially in the load coupling socket.

20. The forced steering arrangement of claim 18, comprising a load coupling ball and an additional forced-steering coupling ball, and a load coupling socket and an additional forced-steering coupling socket, wherein at least one of the measuring device and the additional measuring device is arranged substantially in the forced-steering coupling ball or substantially in a forced-steering coupling socket.

21. A method for forced steering of a vehicle trailer coupled to a towing vehicle, comprising the steps of:
determining with a measuring device a pivot angle and a twist between the towing vehicle and the vehicle trailer,
transmitting a measurement signal from the measuring device to an input of a control device,
generating from the transmitted measurement signal in the control device a control signal, and
transmitting the control signal to a steering device for turning the wheels of at least one axle of the vehicle trailer.

22. The method of claim 21, further comprising the steps of providing two measuring devices and forming in the control device an average value of the measurement signals obtained with the two measuring devices.

23. The method of claim 22, further comprising the step of outputting an error message when a deviation between the measurement signals obtained with the two measuring devices exceed a predeterminable maximum value.

24. The method of claim 21, further comprising the step of determining with the measuring device a tilt angle between the towing vehicle and the vehicle trailer.
